(19) United States
(12) Patent Application Publication
(10) Pub. No.: US 2007/0226069 A1
(43) Pub. Date: Sep. 27, 2007

(54) Photo book display system and method

(75) Inventors: Philippe Sanchez, Mercer Island, WA (US); Tom Kelley, Bainbridge Island, WA (US); Karen Meyers, Suquamish, WA (US); Snowden Armstrong, Seattle, WA (US)

Correspondence Address: KALOW & SPRINGUT LLP, 488 MADISON AVENUE, 19TH FLOOR, NEW YORK, NY, 10022, US

(73) Assignee: PHOTOWORKS, INC., Seattle, WA (US)

(21) Appl. No.: 11/388,128

(22) Filed: Mar. 23, 2006

(51) Int. Cl. G06Q 30/00; B42D 1/00

(52) U.S. Cl. 705/26; 281/21.1

(57) ABSTRACT

A photo book display system is provided having customized photos. The photo book display system, comprising: an outside cover having a top flap, a bottom flap, a closing flap, and an attachment member, the top flap attached to the bottom flap in a rotatable manner, and the closing flap attached to the bottom flap or top flap, the closing flap formed to secure the top flap or bottom flap by extending over one edge of the top flap or bottom flap in the closed position; the attachment member contacting the interior of the outside cover and capable of holding a photo book within the interior of the outside cover; and a photo book comprising an inside cover, spine, and a plurality of pages having images thereon, the spine for holding the plurality of pages and inside cover, the photo book capable of being removably held within the interior of the outside cover by the attachment member. In various embodiments, a computer-implemented method is provided for performing the business of providing the photo book display system.

### BACKGROUND

Conventional photo albums are a convenient and easy way to preserve and display photographs of particular occasions (e.g. wedding, graduation, birthday, sporting event, etc).

Unfortunately, many photo albums use adhesives to hold the pictures in place, which are then covered by clear plastic sheets. In time the adhesive seeps out over the photo, which not only damages the picture, but also causes the pages of the photo album to stick together. Removing old pictures from conventional photo albums and replacing them with new photos can also be difficult because the picture becomes sticky from the messy adhesive.

Many conventional photo albums are too big and bulky to be carried around in a pocket, purse, or handbag. Often at parties, people are asked to show their prized photos of family members or friends at special occasions. However, many embarrassing moments ensue when all that can be shown is an old photo from many years back that is kept in a conventional transparent accordion style photo display in a wallet or purse.

Based on the above, there is a need for new photo book display systems and methods that provide a convenient, attractive way to display and protect photos.

### SUMMARY

The photo book display system provides a new convenient and attractive way to not only display photos, but also protect them. The photo book display system can easily fit into a pocket or handbag and avoids the conventional, big bulky prior art photo albums as well as the sticky mess.

The photo book display system also allows the owner to keep photos of any occasion (e.g., wedding, graduation, birthday, sporting event, etc.) that can be updated by simply removing the photo book from the attachment member in the interior of the outside cover and replacing it with a new photo book. In this way, potentially embarrassing moments showing old photos from a conventional display at parties can be avoided.

In one embodiment, the photo book display system comprises a hidden magnetic closure system that keeps the photos secure in the closed position. The hidden magnetic closure system can be easily opened and closed with one finger.

In another embodiment, a photo book display system is provided, comprising: an outside cover having a top flap, a bottom flap, a closing flap, and an attachment member, the top flap attached to the bottom flap in a rotatable manner, and the closing flap attached to the bottom flap or top flap, the closing flap formed to secure the top flap or bottom flap by extending over one edge of the top flap or bottom flap in the closed position; the attachment member contacting an interior of the outside cover and capable of holding a photo book within the interior of the outside cover; the photo book comprising an inside cover, spine, and a plurality of pages having images thereon, the spine for holding the plurality of pages and the inside cover, the photo book capable of being removably held within the interior of the outside cover by the attachment member.

In an exemplary embodiment, a photo book display system suitable for mailing is provided, comprising: an outside cover made from a single piece of lightweight semi-stiff material folded to form a top flap, a bottom flap, and a closing flap, the closing flap formed to secure the top flap or bottom flap by extending over one edge of the top flap or bottom flap in the closed position; the closing flap comprising a magnetic material for keeping the outside cover in the closed position; and an attachment member contacting an interior of the outside cover and capable of holding a photo book within the interior of the outside cover; the photo book comprising an inside cover, spine, and a plurality of pages having images thereon, the spine for holding the plurality of pages and inside cover, the photo book capable of being removably held within the interior of the outside cover by the attachment member.

In a second exemplary embodiment, a computer implemented method is provided for performing the business of providing a photo book display system, the business method comprising a) receiving a user order and images to be placed into the photo book display; b) receiving payment method for purchase of the photo storage system from the user, c) receiving delivery information from the user; d) verifying the user's payment information and authorization for the sale of the photo book display e) sending the user order information and delivery information f) providing the photo book display having personalization photos from particular events and g) and sending the photo storage display to the user.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 illustrates one embodiment of a perspective view of the photo book display system in the completely open position.

FIG. 2 illustrates one embodiment of a perspective view of the photo book display system in the partially open position or partially closed position.

FIG. 3 illustrates one embodiment of a perspective view of the photo book display system in the closed position.

FIG. 4 illustrates one embodiment of a plan side view of the photo book display system in the closed position.

FIG. 5 illustrates one embodiment of a plan side view of the outside cover of the photo book display system.

FIG. 6 illustrates a block diagram of a computer-implemented method for performing the business of providing a photo book display system.

FIG. 7 illustrates a website user interface for online ordering of a photo book display system, where customer contact information is requested.

FIG. 8 illustrates a website user interface for online ordering of a photo book display system, where the customer can select the color and texture of the outside cover and the color of the inside book cover and can preview the pictures and place the order.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION

Reference will now be made in detail to certain embodiments of the invention, examples of which are illustrated in the accompanying drawings. While the invention will be described in conjunction with the illustrated embodiments, it will be understood that they are not intended to limit the invention to those embodiments. On the contrary, the invention is intended to cover all alternatives, modifications, and equivalents, which may be included within the invention as defined by the appended claims.

Photo Book Display System

In various embodiments, a photo book display system is provided, comprising: an outside cover having a top flap, a bottom flap, a closing flap, and an attachment member, the top flap attached to the bottom flap in a rotatable manner, and the closing flap attached to the bottom flap or top flap, the closing flap formed to secure the top flap or bottom flap by extending over one edge of the top flap or bottom flap in the closed position; the attachment member contacting an interior of the outside cover and capable of holding a photo book within the interior of the outside cover; the photo book comprising an inside cover, spine, and a plurality of pages having images thereon, the spine for holding the plurality of pages and the inside cover, the photo book capable of being removably held within the interior of the outside cover by the attachment member.

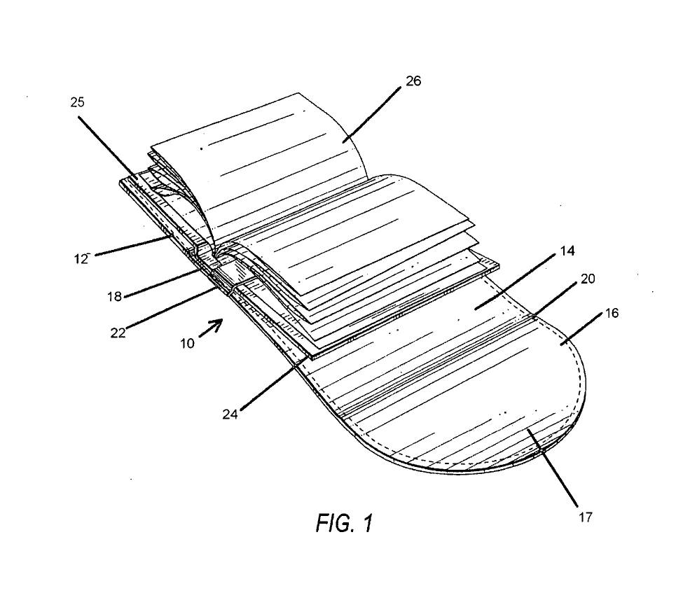

Referring to FIG. 1, the photo book display system (10) comprises an outside cover. The outside cover of the photo display system can be made of any desirable material and is the first level of protection and display of the photo book. Suitable material to make the outside cover include, but is not limited to, cardboard, plastic, metal, leather, vinyl, and the like. The photo book display system as well as its components can be any color and shape. In various embodiments, the outside cover can be decorated with any ornamental design and is chosen to match the color and/or texture of a wallet, purse or handbag.

In various embodiments, the outside cover comprises top flap (12), bottom flap (14) and a closing flap (16) that can be rotatably connected to each other (18 and 20) individually by, for example, adhesives, stitching, clips, pins, grommets, magnetic material, elastic band, string, rubber, VELCRO®, string, rope, chain, staple, rubber band, buckle, belt, adhesive, clip, screw, ring, tape, plastic, or other permanent or temporary fasteners. The rotatable connection allows the closing flap to be folded over an edge of the top flap to close the photo book display system.

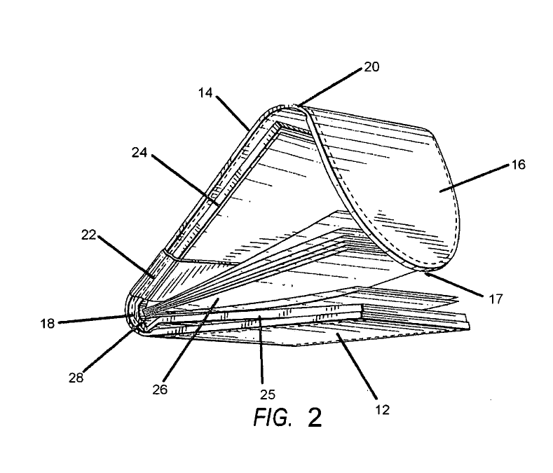

FIG. 2 illustrates one embodiment of a perspective view of the photo book display system in the partially open position, with closing flap (16) folding over an edge of top flap (12). Note that the top flap (12) and inside cover (25) fold in the same direction, while bottom flap (14) and inside cover (24) fold in the same direction, but in an opposite direction to top flap (12) and inside cover (25) in order to open or close the photo book display system.

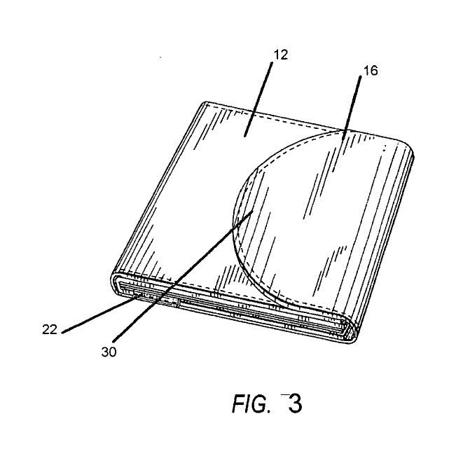

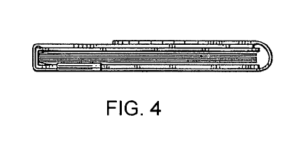

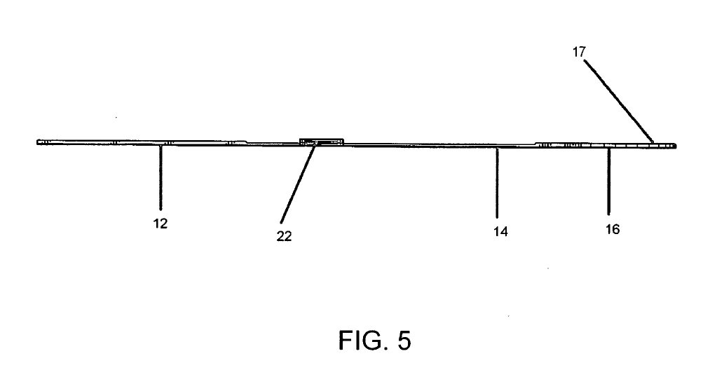

In one preferred embodiment, the outside cover is formed from a single piece of semi stiff material (see FIG. 5), which has folds or creases (18 or 20 shown in FIGS. 1 and 2) that allows the closing flap (16) to be folded over the edge of top flap (12) when the photo book display system is in the closed position (shown in FIG. 3 and FIG. 4).

In various embodiments, referring to FIGS. 1 and 2, the outside cover comprises one or more pockets on the exterior or interior of the cover. In various embodiments, the outside cover, inside book covers (24 and 25), and/or pages (26) carry personalized or customized image related information, messages, designs, or notes based on the occasion being displayed.

In FIGS. 2 and 5, the closing flap (16) comprises a securing member (17) on its interior for holding the closing flap in the closed position, (e.g., either on the top flap or bottom flap) depending on which way the closing flap is closed. The securing member (17) may be on the surface of or imbedded in the closing flap, top flap, or bottom flap. Suitable materials for the securing member include, but are not limited to, adhesives, stitching, clips, pins, grommets, magnetic material, elastic band, string, rubber, VELCRO®, string, slot, rope, chain, staple, rubber band, snaps, buttons, buckle, belt, adhesive, clip, screw, ring, tape, plastic, pocket, or other temporary or permanent fasteners.

In one preferred embodiment, the securing member is a magnetic material or metal imbedded in the interior of the closing flap and substantially adjacent to magnetic material or metal imbedded in the top or bottom flap. The magnetic material or metal is engageable with the closing flap so that the magnetic force attracts the closing flap to the top or bottom flap retaining the closing flap in the closed position. This embodiment is referred to as the hidden closure system, because no protruding parts of the closure system are visible.

Unlike some other securing members, magnetic materials produce no protruding parts on the cover or foredge, and can be opened or closed easily, for example, with one finger. Further, unlike Velcro®, magnetic materials do not gather loose fibers or dust, and do not grab onto clothing.

Referring to FIGS. 1-3 and 5, the outside cover comprises an attachment member (22) disposed on the interior of the outer cover, preferably positioned between the top flap (12) and the bottom flap (14). The attachment member can comprise any material as long as it can removably hold the photo book within the interior of the outer cover. Suitable material for the attachment member include, but are not limited to, adhesives, stitching, clips, pins, grommets, magnetic material, an elastic band, string, rubber, VELCRO®, string, slot, rope, chain, staple, rubber, buckle, belt, adhesive, clip, screw, ring, tape, plastic, pocket, or other permanent or temporary fasteners.

In various embodiments, the attachment member can hold the photo book in place by removably retaining the inside cover, spine, and/or page(s) of the photo book within the interior of the outside cover. To replace the old photo book with a new photo book, the photo book is simply removed from the attachment member and a new book is contacted with the attachment member so as to hold the new photo book within the interior of the outside cover.

In one preferred embodiment, the attachment member (22) is an elastic band and the old photo book is removed and a new photo book is inserted between the band by the inside cover of the new photo book. In this way, the new photo book is retained within the outside cover of the photo book.

The photo book (referring to FIGS. 1 and 2) comprises an inside covers (24 and 25), spine (28), and a plurality of pages (26), some having images thereon. The inside cover of the photo book can be made of any desirable material so long as it provides additional protection to the images (the outside cover provides the first level of protection). Suitable materials for the inside cover of the photo book include, but is not limited to, cardboard, plastic, metal, leather, vinyl, and the like.

In various embodiments, the inside cover can be decorated with any ornamental design. In one embodiment, the photo book inside cover is of a different material and texture than the outside cover. For example, the outside cover can be chosen to match the color and/or texture of a wallet, purse or handbag, while the photo book inside cover can be made from cardboard.

The photo book comprises a spine (18) that binds or holds the pages (26) and cover (24 and 25) in place. Suitable material for the spine includes, but is not limited to, adhesives, stitching, clips, pins, grommets, magnetic material, elastic band, string, rubber, VELCRO®, string, rope, chain, staple, rubber, snaps, adhesive, clip, screw, ring, tape, plastic, or other temporary or permanent binding.

The photo book comprises pages (26) having customized images and/or individualized or personalized image-related information, messages, designs that are specific to the recipient and/or customer.

The term “customized” refers to individualized or personalized image-related information, messages, designs that are specific to the recipient and/or customer. Once the image is stored on the computer, the image can be viewed on a computer monitor and various photo editing applications can be used to edit the image. Parameters for editing the image include, but are not limited to, editing color, removing red eye, tone, resizing (wallet size, 4×6, 5×7, etc.) cropping, sharpening, touching up, image imbedding or superimposing, and the like.

The pages of the photo book can be made of any material so long as an image, personalized image-related information, messages, and/or design can be disposed thereon. In various embodiments, the images are digital images and printed from a computer, using a digital photographic printer, on to photographic paper from various manufactures (e.g. Kodak, Fuji, Epson, Cannon, etc.).

In various embodiments, the pages of the photo book each have first and second sides, and each page is folded so that an image appears on the first side of each page of the photo book. For example, to produce the pages having images thereon, an image is printed on one side of the page, the other side of the page has no image on it, the next page also has an image on one side and no image on the other. The two pages are combined together so that the two sides without images on them are placed on top of each other so that images appear on the front and back of each page (double-sided). In various embodiments images are printed on one continuous sheet, which has creases on a division line. This continuous sheet can be folded along the division line to produce pages in an accordion style with double-sided images and/or personalized notes.

In various embodiments, the pages may have adhesive thereon to glue opposing sides that do not have images together. Alternatively, the pages can be folded together in an accordion style without adhesives. In various embodiments, the pages are folded substantially in half so that each side of the page carries a customized image, message, design, and/or note based on the occasion being displayed.

Business Method

In various embodiments, a computer-implemented method for performing the business of providing a photo book display system is provided. The business method comprises: a) receiving a user order and images to be placed into the photo book display; b) receiving payment method for purchase of the photo book display system from the user, c) receiving delivery information from the user; d) verifying the user's payment information and authorization for the sale of the photo book display e) sending the user order information and delivery information f) providing the photo book display system having personalization photos from particular events and g) and sending the photo storage display to the user.

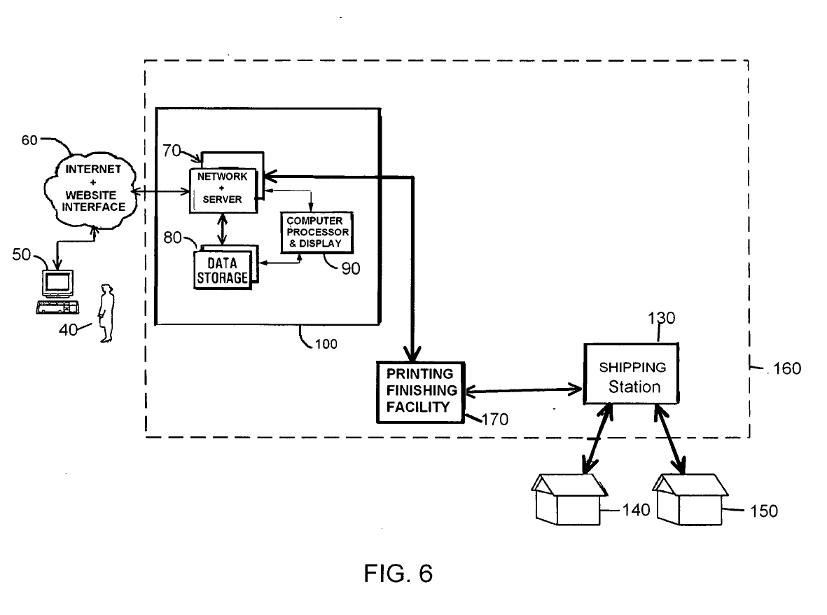

FIG. 6 illustrates a block diagram of a computer-implemented method for performing the business of providing a photo book display system (160). On line ordering of the photo book display system can be performed by the customer (40) using a computer (50) to sign on the Internet (60) to a photo service provider website, such as photoworks.com.

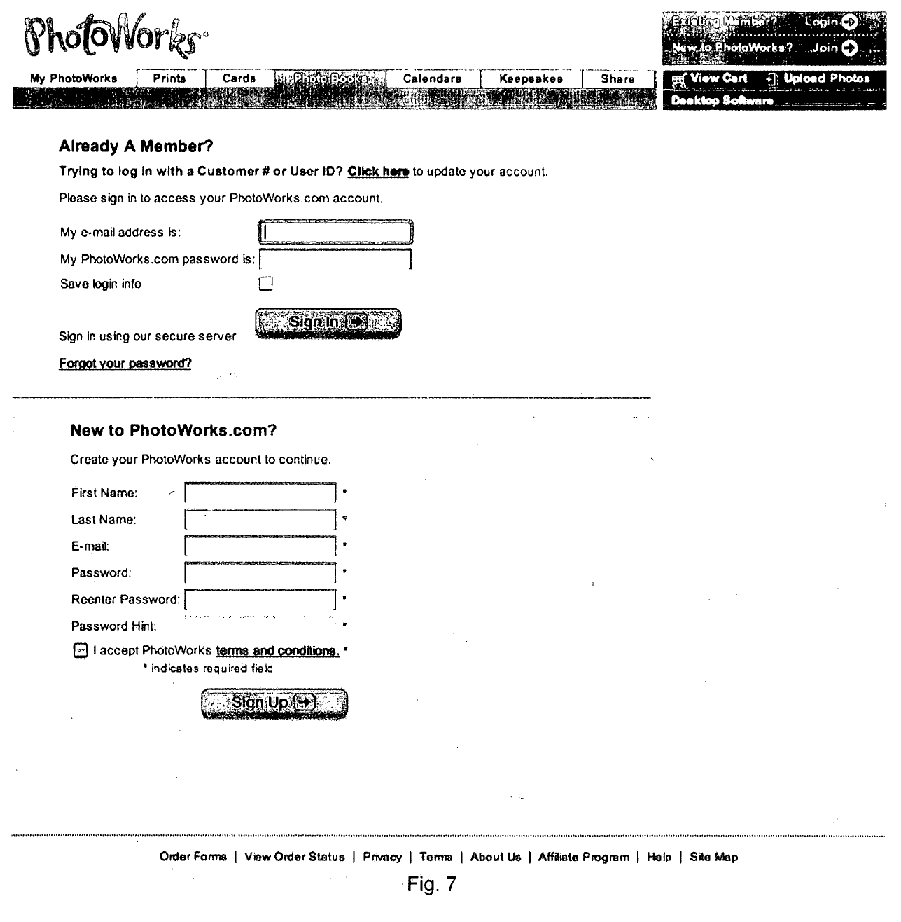

The website is powered by a network server (70) to serve as a web user interface between a photo professional and the customer. The customer log in appears on the website (shown in FIG. 7) and the customer supplies his/her user name, password, contact information, payment information and shipping address. The customer provides his/her digital images over the internet to the photo professional to be placed in the photo display system. Typical digital image formats include, but are not limited to, Adobe PDF, TIF, JPEG, or the like. The data center (100) comprises network server (70), data storage (80), computer processor and display monitor (90). The customer can view the digital images sent using the web user interface (60) and, if satisfactory, place one or more orders by selecting the outside cover texture and color to be used in the photo display system. Optionally, the customer can send the images for approval by a photo professional for editing. The texture and color of the inside cover of the photo book can be selected by the customer and personalized or customized messages, designs, and/or notes based on the occasion being displayed can be selected as well. The user-website interface displays confirmation of price, quantity and shipping instruction for acceptance of the order. Upon receiving the data from the customer, the data is transmitted to the server and stored on the data storage system (80). The data can be accessed by the photo professional using computer processor and display (90), where the digital photos can be viewed and edited (e.g., color, tone, resizing, cropping, sharpening, image imbedding or superimposing images, and the like) using software known in the art, such as for example, Adobe Photoshop or other viewing and editing software. The edited images can be sent via the network server (70) to the printing facility (170), which comprises printers for printing images on the paper as discussed above.

After printing, the images can be finished by, for example cutting, folding, optionally gluing, scaling and sizing the pages, selecting the proper texture and color of the inside cover and outside covers of the photo book and binding the pages and inside cover of the photo book. The completed photo book display system is physically sent to the shipping station (130) where it is packaged labeled, postage calculated and sent to the customer at the requested shipping address(es) (140, 150).

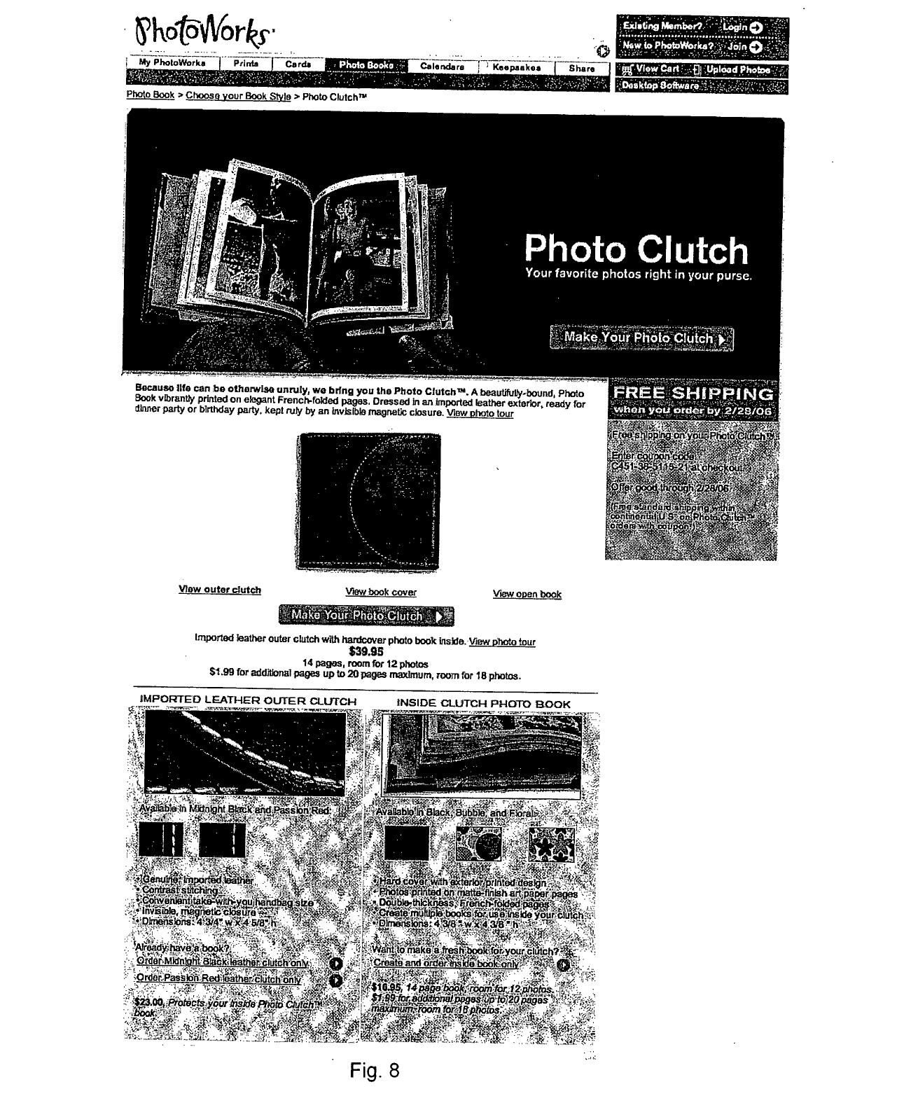

FIG. 7 illustrates an online ordering website of the photo book display system from, for example, http://www.photoworks.com. The customer creates their account and password and then proceeds to select the color of the outside cover and color of the inside cover (e.g., website shown in FIG. 8). The customer is then prompted to select a layout for the photo book, where the customer sends digital pictures, which can be previewed online and then the customer can place the order for the photo book display system.

It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings.

What is claimed is:

1. A photo book display system, comprising:
an outside cover having a top flap, a bottom flap, a closing flap, and an attachment member, the top flap attached to the bottom flap in a rotatable manner, and the closing flap attached to the bottom flap or top flap, the closing flap formed to secure the top flap or bottom flap by extending over one edge of the top flap or bottom flap in the closed position; the attachment member contacting an interior of the outside cover and capable of holding a photo book within the interior of the outside cover;
the photo book comprising an inside cover, spine, and a plurality of pages having images thereon, the spine for holding the plurality of pages and the inside cover, the photo book capable of being removably held within the interior of the outside cover by the attachment member.

2. A photo book display system according to claim 1, wherein the outside cover matches the color and texture of a wallet, purse or handbag.

3. A photo book display system according to claim 1, wherein the photo book can be replaced with a new photo book by removing the photo book from the attachment member and replacing it with the new photo book.

4. A photo book display system according to claim 1, wherein the closing flap comprises a securing member for keeping the outside cover in the closed position.

5. A photo book display system according to claim 1, the securing member comprises a magnetic for keeping the outside cover in the closed position.

6. A photo book display system according to claim 1, wherein the closing flap is attached to the bottom flap or top flap in a rotatable manner.

7. A photo book display system according to claim 1, wherein each page has first and second sides, and each page is folded so that an image appears on the first side of each page of the photo book.

8. A photo book display system according to claim 1, wherein the images are digital and printed from a computer.

9. A photo book display system according to claim 1, wherein at least one page, outside cover, and/or inside cover has a personalized note.

10. A photo book display system according to claim 1, wherein the outside cover is formed from a single piece of semi-stiff material.

11. A photo book display system according to claim 1, wherein the closing flap comprises a securing member for keeping the outside cover in the closed position.

12. A photo book display system according to claim 1, the securing member comprises a magnetic material for keeping the cover in the outside closed position.

13. A photo book display system suitable for mailing, comprising: an outside cover made from a single piece of lightweight semi-stiff material folded to form a top flap, a bottom flap, and a closing flap, the closing flap formed to secure the top flap or bottom flap by extending over one edge of the top flap or bottom flap in the closed position; the closing flap comprising a magnetic material for keeping the outside cover in the closed position; and an attachment member contacting an interior of the outside cover and capable of holding a photo book within the interior of the outside cover; the photo book comprising an inside cover, spine, and a plurality of pages having images thereon, the spine for holding the plurality of pages and inside cover, the photo book capable of being removably held within the interior of the outside cover by the attachment member.

14. A photo book display system according to claim 13, wherein the outside cover matches the color and texture of a wallet, purse or handbag.

15. A photo book display system according to claim 13, wherein the photo book can be replaced with a new photo book by removing the photo book from the attachment means and replacing it with the new photo book.

16. A photo book display system according to claim 13, wherein each page is has first and second sides, and each page is folded so that an image appears on the first side of each page of the photo book.

17. A photo book display system according to claim 13, wherein the images are digital and printed from a computer.

18. A photo book display system according to claim 13, wherein at least one page, inside cover and/or outside cover has a personalized note.

19. A computer implemented method for performing the business of providing a photo book display system according to claim 1, the business method comprising a) receiving a user order and images to be placed into the photo book display; b) receiving payment method for purchase of the photo storage system from the user, c) receiving delivery information from the user; d) verifying the user's payment information and authorization for the sale of the photo book display e) sending the user order information and delivery information f) providing the photo book display having personalization photos from particular events and g) and sending the photo storage display to the user.

20. A computer implemented method for performing the business of providing a photo book display system according to claim 1, wherein steps a)-e) are performed over a web user interface over the Internet.
